(19) United States
(12) Patent Application Publication
(10) Pub. No.: US 2016/0235088 A1
(43) Pub. Date: Aug. 18, 2016

(54) FROZEN DESSERT MIXES USING SOY PROTEIN PRODUCTS

(71) Applicant: BURCON NUTRASCIENCE (MB) CORP., Winnipeg (CA)

(72) Inventors: Johann F. Tergesen, Vancouver (CA); Kevin I. Segall, Winnipeg (CA); Sarah Medina, Winnipeg (CA)

(73) Assignee: BURCON NUTRASCIENCE (MB) CORP., Winnipeg (CA)

(21) Appl. No.: 14/978,919

(22) Filed: Dec. 22, 2015

Related U.S. Application Data
(63) Continuation of application No. 14/246,389, filed on Apr. 7, 2014, now abandoned.

(51) Int. Cl. A23G 9/38; A23G 9/32; A23J 1/14

(52) U.S. Cl. CPC A23G 9/38; A23J 1/142; A23G 9/32; A23V 2002/00

(57) ABSTRACT

A soy protein product having a protein content of at least about 60 wt% (N×6.25) d.b., preferably at least about 90 wt %, and being completely soluble at pH values of less than about 4.4 and heat stable at such pH values is used to provide, at least in part, the protein component of a dairy analogue or plant/dairy blend frozen dessert mix.

### REFERENCE TO RELATED APPLICATIONS

This application is a continuation of U.S. patent application Ser. No. 14/246,389 filed Apr. 7, 2014, which is a continuation of U.S. patent application Ser. No. 13/790,000 filed Mar. 8, 2013, claiming priority under 35 USC 119(e) from U.S. Provisional Patent Application Nos. 61/739,031 and 61/608,136 filed Dec. 19, 2012 and Mar. 8, 2012 respectively.

### FIELD OF INVENTION

The invention relates to mixes used in the preparation of dairy analogue frozen dessert products and frozen dessert products that are plant/dairy blends, prepared using a soy protein product, particularly an isolate.

### BACKGROUND TO THE INVENTION

In U.S. patent applications Ser. No. 12/603,087 filed Oct. 21, 2009 (US Patent Publication No. 2010/0098818 published Apr. 22, 2010), Ser. No. 12/923,897 filed Oct. 13, 2010 (US Patent Publication No. 2011/0038993 published Feb. 17, 2011) and 12/998,422 filed Jun. 1, 2011 (US Patent Publication No. 2011/0236556 published Sep. 29, 2011) (“S701”), assigned to the assignee hereof and the disclosures of which are incorporated herein by reference, there is described the preparation of a soy protein product having a protein content of at least about 60 wt % (N×6.25) d.b., preferably at least about 90 wt % (N×6.25) d.b., more preferably at least about 100 wt % (N×6.25) d.b., that produces transparent and heat stable solutions at low pH values and, therefore, may be used for protein fortification of, in particular, soft drinks and sports drinks, as well as other aqueous systems, without precipitation of protein.

The soy protein product described therein has a unique combination of parameters not found in other soy protein products. The product is completely soluble in aqueous solution at acid pH values less than about 4.4 and is heat stable in this pH range permitting thermal processing of the aqueous solution of the product, such as in hot fill applications. Given the complete solubility of the product, no stabilizers or other additives are necessary to maintain the protein in solution or suspension. The soy protein product has been described as having no “beany” flavour and no off odours. The product is low in phytic acid, generally less than about 1.5 wt %, preferably less than about 0.5 wt %. No enzymes are required in the production of the soy protein product. The soy protein product is also highly soluble at about pH 7. The soy protein product is preferably an isolate having a protein content of at least about 90 wt % (N×6.25) d.b., preferably at least about 100 wt% (N×6.25) d.b.

The soy protein product, in one aspect, is provided by a method, which comprises:
(a) extracting a soy protein source with an aqueous calcium salt solution, generally calcium chloride solution, to cause solubilization of soy protein from the protein source and to form an aqueous soy protein solution,
(b) at least partially separating the aqueous soy protein solution from residual soy protein source,
(c) optionally diluting the aqueous soy protein solution,
(d) adjusting the pH of the aqueous soy protein solution to a pH of about 1.5 to about 4.4, preferably about 2 to about 4, to produce an acidified clear soy protein solution,
(e) optionally polishing the acidified clear soy protein solution to remove residual particulates,
(f) optionally concentrating the aqueous clear soy protein solution while maintaining the ionic strength substantially constant by using a selective membrane technique,
(g) optionally diafiltering the concentrated soy protein solution, and
(h) optionally drying the concentrated soy protein solution.

In U.S. patent applications No. 12/828,212 filed Jun. 30, 2010 (US Patent Publication No. 2010-0330249 published Dec. 30, 2010), Ser. No. 13/067,201 filed May 17, 2011 (US Patent Publication No. 2011-0223295 published Sep. 15, 2011) and 13/378,680 filed Feb. 23, 2012 (US Patent Publication No. 2012-0141651 published Jun. 7, 2012) (“S703”), assigned to the assignee hereof and the disclosures of which are incorporated herein by reference, there is described a procedure for obtaining a soy protein product having similar properties to those obtained according to the aforementioned applications in which the soy protein source is extracted at low pH values, generally about 1.5 to about 5.

The soy protein product which has a protein content of at least about 60 wt % (N×6.25) d.b., preferably at least about 90 wt % (N×6.25) d.b., more preferably at least about 100 wt % (N×6.25) d.b., in one aspect, is made by a method, which comprises:
(a) extracting a soy protein source with aqueous calcium salt solution, generally calcium chloride solution, at low pH, generally about 1.5 to about 5.0, to cause solubilization of soy protein from the protein source and to form an aqueous soy protein solution,
(b) at least partially separating the aqueous soy protein solution from residual soy protein source,
(c) optionally diluting the aqueous soy protein solution,
(d) optionally adjusting the pH of the aqueous protein solution to a value within the range of about 1.5 to about 5.0, preferably about 1.5 to about 4.4, more preferably about 2.0 to about 4.0, and differing from the pH of extraction,
(e) optionally polishing the aqueous soy protein solution to remove residual particulates,
(f) optionally concentrating the aqueous soy protein solution while maintaining the ionic strength substantially constant by using a selective membrane technique,
(g) optionally diafiltering the concentrated soy protein solution, and
(h) optionally drying the concentrated and diafiltered soy protein solution.

### SUMMARY OF THE INVENTION

It has now been found that these novel soy protein products having a protein content of at least about 60 wt % (N×6.25) d.b., preferably at least about 90 wt % and more preferably at least about 100 wt %, may be effectively used in dairy analogue frozen dessert mixes or mixes which are blends of dairy and plant ingredients, as an at least partial substitute for conventional proteinaceous ingredients derived from milk, soy or other sources. Such frozen dessert mixes, which have good flavour properties, may then be frozen in the preparation of frozen dessert products, which also have good flavour properties. Such frozen dessert products include but are not limited to scoopable frozen desserts, soft serve frozen desserts and frozen novelty products such as molded or extruded products that may or may not be provided on sticks. Such frozen dessert products may contain any manner of inclusion, such as syrups, fruits, nuts and/or other particulates, or coatings in the case of the frozen novelty products, in combination with the frozen dessert mix.

In very general terms, frozen dairy dessert mixes, dairy analogue frozen dessert mixes and mixes that are plant/dairy blends, all typically comprise water, protein, fat, flavourings, sweetener and other solids along with stabilizers and emulsifiers. The proportions of these components vary depending on the desired composition of the frozen dessert product. The range of dairy analogue or plant/dairy blend frozen dessert products that may be prepared from dairy analogue or plant/dairy blend frozen dessert mixes may be considered to be equivalent to the range of frozen dairy dessert products that may be prepared from frozen dairy dessert mixes.

Suggested mix compositions for a variety of frozen dairy desserts can be found at http//www.uogueiph.ca/foodscience/dairy-science-and-technology/dairy-products/ice-cream/ice-cream-formulations/suggested-mixes (Professor H. Douglas Goff, Dairy Science and Technology Education Series, University of Guelph, Canada). To illustrate the differences in composition between some various types of frozen dairy dessert mixes, sample compositions from this reference are shown below in Tables 1-6.

TABLE 1
Sample suggested mix composition
for hard frozen ice cream product

| Component | % by weight |
|---|---|
| Milkfat | 10.0 |
| Milk solids-not-fat¹ | 11.0 |
| Sucrose | 10.0 |
| Corn Syrup Solids | 5.0 |
| Stabilizer | 0.35 |
| Emulsifier | 0.15 |
| Water | 63.5 |

¹Proteins are a component of this phase along with other compounds contributed by the milk such as lactose and salts. The protein content of the milk solids-not-fat is on average 38% (http://www.uoguelph.ca/foodscience/dairy-science-and-technology/dairy-products/ice-cream/ice-cream-formulations/ice-cream-mix-general-c (Professor H. Douglas Goff, Dairy Science and Technology Education Series, University of Guelph, Canada)).

Based on this value, the protein content of the above ice cream mix is approximately 4.18% by weight.

TABLE 2
Sample suggested mix composition for low fat ice cream product

| Component | % by weight |
|---|---|
| Milkfat | 3.0 |
| Milk solids-not-fat¹ | 13.0 |
| Sucrose | 11.0 |
| Corn Syrup Solids | 6.0 |
| Stabilizer | 0.35 |
| Emulsifier | 0.10 |
| Water | 66.35 |

¹Based on a milk solids-not-fat protein content of 38%, the protein content of the above low fat ice cream mix is approximately 4.94% by weight.

TABLE 3
Sample suggested mix composition for light ice cream product

| Component | % by weight |
|---|---|
| Milkfat | 6.0 |
| Milk solids-not-fat¹ | 12.0 |
| Sucrose | 13.0 |
| Corn Syrup Solids | 4.0 |
| Stabilizer | 0.35 |
| Emulsifier | 0.15 |
| Water | 64.5 |

¹Based on a milk solids-not-fat protein content of 38%, the protein content of the above light ice cream mix is approximately 4.56% by weight.

TABLE 4
Sample suggested mix composition
for soft frozen ice cream product

| Component | % by weight |
|---|---|
| Milkfat | 10.0 |
| Milk solids-not-fat¹ | 12.5 |
| Sucrose | 13.0 |
| Stabilizer | 0.35 |
| Emulsifier | 0.15 |
| Water | 64.0 |

¹Based on a milk solids-not-fat protein content of 38%, the protein content of the above ice cream mix is approximately 4.75% by weight.

TABLE 5
Sample suggested mix composition for sherbet¹

| Component | % by weight |
|---|---|
| Milkfat | 0.5 |
| Milk solids-not-fat² | 2.0 |
| Sucrose | 24.0 |
| Corn Syrup Solids | 9.0 |
| Stabilizer/Emulsifier | 0.30 |
| Citric acid (50% sol.)³ | 0.70 |
| Water | 63.5 |

¹Fruit is added at about 25% to the mix.
²Based on a milk solids-not-fat protein content of 38%, the protein content of the above sherbet mix is approximately 0.76% by weight.
³Acid is added just before freezing, after aging of the mix

TABLE 6
Sample suggested mix composition for frozen yogurt

| Component | % by weight |
|---|---|
| Milkfat | 2.0 |
| Milk solids-not-fat¹ | 14.0 |
| Sugar | 15.0 |
| Stabilizer | 0.35 |
| Water | 68.65 |

¹Based on a milk solids-not-fat protein content of 38%, the protein content of the above frozen yogurt mix is approximately 5.32% by weight.

As mentioned above, the proportion of components in dairy analogue or plant/dairy blend frozen dessert mixes, may vary similarly to the proportions of components in frozen dairy dessert mixes. Frozen dairy dessert mixes utilize dairy sources of fat and protein/solids. Dairy analogue frozen dessert mixes are entirely plant based, while plant/dairy blends utilize a combination of plant and dairy ingredients.

The typical types of ingredients used in dairy analogue or plant/dairy blend frozen dessert mix formulations are described below. Other types of ingredients not mentioned may also be used in such frozen dessert mix formulations.

The fat source used for the frozen dessert mixes may be any convenient food grade dairy or plant derived fat source or blend of fat sources. Suitable fat sources include but are not limited to milk, cream, butteroil, soy milk, soy oil, coconut oil and palm oil. It should be noted that certain ingredients may provide multiple components to the formulations. For example, the inclusion of milk or soymilk in the formulation provides fat, protein, other solids and water. The fat level in the frozen dessert mixes may range from about 0 to about 30 wt %, preferably about 0 to about 18 wt %.

The protein source used for the frozen dessert mixes may be any convenient food grade dairy or plant derived protein source or blend of protein sources. Suitable protein sources include but are not limited to cream, milk, skim milk powder, whey protein concentrate, whey protein isolate, soy protein concentrate and soy protein isolate. As mentioned above, certain ingredients may provide multiple components, including protein, to the formulation. The protein level in the frozen dessert mixes may range from about 0.1 to about 18 wt %, preferably about 0.1 to about 6 wt %.

The choice and level of sweetener or sweeteners used in the frozen dessert mixes will influence factors such as the sweetness, caloric value, and texture of the frozen dessert product. Various sweeteners may be utilized in the frozen dessert mixes, including but not limited to sucrose, corn starch derived ingredients, sugar alcohols, sucralose and acesulfame potassium. Blends of sweeteners are often used to get the desired qualities in the final product. The overall level of added sweetener in the frozen dessert mixes may range from about 0 to about 45 wt %, preferably about 0 to about 35 wt %.

Stabilizers used in the frozen dessert mixes may include but are not limited to locust bean gum, guar gum, carrageenan, carboxymethyl cellulose and gelatin. The stabilizer level in the frozen dessert mixes may be about 0% to about 3%, preferably about 0% to about 1%.

Emulsifiers used in the frozen dessert mixes may include but are not limited to egg yolk, monoglycerides, diglycerides and polysorbate 80. The emulsifier level in the frozen dessert mixes may range from about 0% to about 4%, preferably about 0% to about 2%.

In the present invention, the soy protein product described above is incorporated in the dairy analogue or plant/dairy blend frozen dessert mix to supply at least a portion of the required protein and solids.

### GENERAL DESCRIPTION OF INVENTION

The initial step of the process of providing the soy protein product used herein involves solubilizing soy protein from a soy protein source. The soy protein source may be soybeans or any soy product or by-product derived from the processing of soybeans, including but not limited to soy meal, soy flakes, soy grits and soy flour. The soy protein source may be used in the full fat form, partially defatted form or fully defatted form. Where the soy protein source contains an appreciable amount of fat, an oil-removal step generally is required during the process. The soy protein recovered from the soy protein source may be the protein naturally occurring in soybean or the proteinaceous material may be a protein modified by genetic manipulation but possessing characteristic hydrophobic and polar properties of the natural protein.

Protein solubilization from the soy protein source material is effected most conveniently using calcium chloride solution, although solutions of other calcium salts, may be used. In addition, other alkaline earth metal compounds may be used, such as magnesium salts. Further, extraction of the soy protein from the soy protein source may be effected using calcium salt solution in combination with another salt solution, such as sodium chloride. Additionally, extraction of the soy protein from the soy protein source may be effected using water or other salt solution, such as sodium chloride, with calcium salt subsequently being added to the aqueous soy protein solution produced in the extraction step. Precipitate formed upon addition of the calcium salt is removed prior to subsequent processing.

As the concentration of the calcium salt solution increases, the degree of solubilization of protein from the soy protein source initially increases until a maximum value is achieved. Any subsequent increase in salt concentration does not increase the total protein solubilized. The concentration of calcium salt solution which causes maximum protein solubilization varies depending on the salt concerned. It is usually preferred to utilize a concentration value less than about 1.0 M, and more preferably a value of about 0.10 to about 0.15 M.

In a batch process, the salt solubilization of the protein is effected at a temperature of from about 1° C. to about 100° C., preferably about 15° to about 65° C., more preferably about 50° to about 60° C. when the procedure of U.S. patent applications Ser. Nos. 12/603,087, 12/923,897 and 12/998,422 is followed or more preferably about 20° C. to about 35° C. when the procedure of U.S. patent applications Ser. Nos. 12/828,212, 13/067,201 and 13/378,680 is followed, preferably accompanied by agitation to decrease the solubilization time, which is usually about 1 to about 60 minutes. It is preferred to effect the solubilization to extract substantially as much protein from the soy protein source as is practicable, so as to provide an overall high product yield.

In a continuous process, the extraction of the soy protein from the soy protein source is carried out in any manner consistent with effecting a continuous extraction of soy protein from the soy protein source. In one embodiment, the soy protein source is continuously mixed with the calcium salt solution and the mixture is conveyed through a pipe or conduit having a length and at a flow rate for a residence time sufficient to effect the desired extraction in accordance with the parameters described herein. In such a continuous procedure, the salt solubilization step is effected in a time of about 1 minute to about 60 minutes, preferably to effect solubilization to extract substantially as much protein from the soy protein source as is practicable. The solubilization in the continuous procedure is effected at temperatures between about 1° C. and about 100° C., preferably about 15° to about 65° C., more preferably about 50° to about 60° C. when the procedure of U.S. patent applications Ser. Nos. 12/603,087, 12/923,897 and 12/998,422 is followed or more preferably about 20° C. to about 35° C. when the procedure of U.S. patent applications Ser. Nos. 12/828,212, 13/067,201 and 13/378,680 is followed.

When the procedure of U.S. patent applications Ser. Nos. 12/603,087, 12/923,897 and 12/998,422 is carried out, the extraction is generally conducted at a pH of about 5 to about 11, preferably about 5 to about 7. When the procedure of U.S. patent applications Ser. Nos. 12/828,212, 13/067,201 and 13/378,680 is carried out, the extraction is carried out at low pH, generally about 1.5 to about 5.0, such as about 4.5 to about 5.0. The pH of the extraction system (soy protein source and calcium salt solution) may be adjusted to any desired value within the desired range by the use of any convenient food grade acid, usually hydrochloric acid or phosphoric acid, or food grade alkali, usually sodium hydroxide, as required.

The concentration of soy protein source in the calcium salt solution during the solubilization step may vary widely. Typical concentration values are about 5 to about 15% w/v.

The protein extraction step with the aqueous salt solution has the additional effect of solubilizing fats which may be present in the soy protein source, which then results in the fats being present in the aqueous phase.

The protein solution resulting from the extraction step generally has a protein concentration of about 5 to about 50 g/L, preferably about 10 to about 50 g/L.

The aqueous calcium salt solution may contain an antioxidant. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit oxidation of any phenolics in the protein solution.

The aqueous protein solution resulting from the extraction step then may be separated from the residual soy protein source, in any convenient manner, such as by employing a decanter centrifuge or any suitable sieve, followed by disc centrifugation and/or filtration, to remove residual soy protein source material. The separation step is typically conducted at the same temperature as the protein solubilization step, but may be conducted at any temperature within the range of about 1° to about 100° C., preferably about 15° to about 65° C., more preferably about 50° to about 60° C. when the procedure of U.S. patent applications Ser. Nos. 12/603,087, 12/923,897 and 12/998,422 is followed or more preferably about 20° to about 35° C. when the procedure of U.S. patent applications Ser. Nos. 12/828,212, 13/067,201 and 13/378,680 is followed. The separated residual soy protein source may be dried for disposal. Alternatively, the separated residual soy protein source may be processed to recover some residual protein. The separated residual soy protein source may be re-extracted with fresh calcium salt solution and the protein solution yielded upon clarification combined with the initial protein solution for further processing as described below. Alternatively, the separated residual soy protein source may be processed by a conventional isoelectric precipitation procedure or any other convenient procedure to recover residual protein.

The aqueous soy protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer in the quantity described may be added in the extraction steps.

Where the soy protein source contains significant quantities of fat, as described in U.S. Pat. Nos. 5,844,086 and 6,005,076, assigned to the assignee hereof and the disclosures of which are incorporated herein by reference, then the defatting steps described therein may be effected on the separated aqueous protein solution. Alternatively, defatting of the separated aqueous protein solution may be achieved by any other convenient procedure.

The aqueous soy protein solution may be treated with an adsorbent, such as powdered activated carbon or granulated activated carbon, to remove colour and/or odour compounds. Such adsorbent treatment may be carried out under any convenient conditions, generally at the ambient temperature of the separated aqueous protein solution. For powdered activated carbon, an amount of about 0.025% to about 5% w/v, preferably about 0.05% to about 2% w/v, is employed. The adsorbing agent may be removed from the soy solution by any convenient means, such as by filtration.

The resulting aqueous soy protein solution may be diluted generally with about 0.1 to about 10 volumes, preferably about 0.5 to about 2 volumes, of aqueous diluent in order to decrease the conductivity of the aqueous soy protein solution to a value of generally below about 105 mS, preferably about 4 to about 21 mS when the procedure of U.S. Ser. Nos. 12/603,087, 12/923,897 and 12/998,422 is carried out, or preferably about 4 to about 31 mS when the procedure of US 12/828,212, 13/067,201 and 13/378,680 is carried out. Such dilution is usually effected using water, although dilute salt solution, such as sodium chloride or calcium chloride, having a conductivity of up to about 3 mS, may be used.

The diluent with which the soy protein solution is mixed typically has the same temperature as the soy protein solution, but the diluent may have a temperature of about 1° to about 100° C., preferably about 15° to about 65° C., more preferably about 50° to about 60° C. when the procedure of U.S. patent applications Ser. Nos. 12/603,087, 12/923,897 and 12/998,422 is followed or more preferably about 20° to about 35° C. when the procedure of U.S. patent applications Ser. Nos. 12/828,212, 13/067,201 and 13/378,680 is followed.

The optionally diluted soy protein solution then is adjusted in pH to a value of about 1.5 to about 4.4, preferably about 2 to about 4 when the procedure of U.S. Ser. Nos. 12/607,087, 12/923,897 and 12/998,422 is carried out and when the procedure of U.S. Ser. Nos. 12/828,212, 13/067,201 and 13/378,680 is carried out, optionally to a value different from the extraction pH but still within the range of about 1.5 to about 5.0, preferably about 1.5 to about 4.4, more preferably about 2.0 to about 4.0, by the addition of any suitable food grade acid, to result in an acidified aqueous soy protein solution. The acidified aqueous soy protein solution has a conductivity of generally below about 110 mS for a diluted soy protein solution or generally below about 115 mS for an undiluted soy protein solution, preferably about 4 to about 26 mS when the procedure of U.S. Ser. Nos. 12/607,087, 12/923,897 and 12/998,422 is carried out and preferably about 4 to about 36 mS when the procedure of Ser. Nos. 12/828,212, 13/067,201 and 13/378,680 is carried out.

As an alternative to the earlier separation of the residual soy protein source, the aqueous soy protein solution and the residual soy protein source material, may be optionally diluted and pH adjusted together and then the acidified aqueous soy protein solution is clarified and separated from the residual soy protein source material by any convenient technique as discussed above. The acidified aqueous soy protein solution may optionally be defatted, optionally treated with an adsorbent and optionally treated with defoamer as described above.

The acidified aqueous soy protein solution may be subjected to a heat treatment to inactivate heat labile anti-nutritional factors, such as trypsin inhibitors, present in such solution as a result of extraction from the soy protein source material during the extraction step. Such a heating step also provides the additional benefit of reducing the microbial load. Generally, the protein solution is heated to a temperature of about 70° to about 160° C., for about 10 seconds to about 60 minutes, preferably about 80° to about 120° C. for about 10 seconds to about 5 minutes, more preferably about 85° to about 95° C., for about 30 seconds to about 5 minutes. The heat treated acidified soy protein solution then may be cooled for further processing as described below, to a temperature of about 2° to about 65° C., preferably about 50° C. to about 60° C. when the procedure of US Patent applications Ser. Nos. 12/603,087, 12/923,897 and 12/998,422 is followed or preferably about 20° to about 35° C. when the procedure of U.S. patent applications Ser. Nos. 12/828,212, 13/067,201 and 13/378,680 is followed.

The optionally diluted, acidified and optionally heat treated protein solution may optionally be polished by any convenient means, such as by filtering, to remove any residual particulates.

If of adequate purity, the resulting acidified aqueous soy protein solution may be directly dried to produce a soy protein product. In order to provide a soy protein product having a decreased impurities content and a reduced salt content, such as a soy protein isolate, the acidified aqueous soy protein solution may be processed prior to drying.

The acidified aqueous soy protein solution may be concentrated to increase the protein concentration thereof while maintaining the ionic strength thereof substantially constant. Such concentration generally is effected to provide a concentrated soy protein solution having a protein concentration of about 50 to about 300 g/L, preferably about 100 to about 200 g/L.

The concentration step may be effected in any convenient manner consistent with batch or continuous operation, such as by employing any convenient selective membrane technique, such as ultrafiltration or diafiltration, using membranes, such as hollow-fibre membranes or spiral-wound membranes, with a suitable molecular weight cut-off, such as about 3,000 to about 1,000,000 Daltons, preferably about 5,000 to about 100,000 Daltons, having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include not only the ionic species of the food grade salt but also low molecular weight materials extracted from the source material, such as carbohydrates, pigments, low molecular weight proteins and anti-nutritional factors, such as trypsin inhibitors, which are themselves low molecular weight proteins. The molecular weight cut-off of the membrane is usually chosen to ensure retention of a significant proportion of the protein in the solution, while permitting contaminants to pass through having regard to the different membrane materials and configurations.

The concentrated soy protein solution then may be subjected to a diafiltration step using water or a dilute saline solution. The diafiltration solution may be at its natural pH or at a pH equal to that of the protein solution being diafiltered or at any pH value in between. Such diafiltration may be effected using from about 1 to about 40 volumes of diafiltration solution, preferably about 2 to about 25 volumes of diafiltration solution. In the diafiltration operation, further quantities of contaminants are removed from the aqueous soy protein solution by passage through the membrane with the permeate. This purifies the aqueous protein solution and may also reduce its viscosity. The diafiltration operation may be effected until no significant further quantities of contaminants or visible colour are present in the permeate or until the retentate has been sufficiently purified so as, when dried, to provide a soy protein isolate with a protein content of at least about 90 wt % (N×6.25) d.b. Such diafiltration may be effected using the same membrane as for the concentration step. However, if desired, the diafiltration step may be effected using a separate membrane with a different molecular weight cut-off, such as a membrane having a molecular weight cut-off in the range of about 3,000 to about 1,000,000 Daltons, preferably about 5,000 to about 100,000 Daltons, having regard to different membrane materials and configuration.

Alternatively, the diafiltration step may be applied to the acidified aqueous protein solution prior to concentration or to the partially concentrated acidified aqueous protein solution. Diafiltration may also be applied at multiple points during the concentration process. When diafiltration is applied prior to concentration or to the partially concentrated solution, the resulting diafiltered solution may then be additionally concentrated. The viscosity reduction achieved by diafiltering multiple times as the protein solution is concentrated may allow a higher final, fully concentrated protein concentration to be achieved. This reduces the volume of material to be dried.

The concentration step and the diafiltration step may be effected herein in such a manner that the soy protein product subsequently recovered contains less than about 90 wt % protein (N×6.25) d.b., such as at least about 60 wt % protein (N×6.25) d.b. By partially concentrating and/or partially diafiltering the aqueous soy protein solution, it is possible to only partially remove contaminants. This protein solution may then be dried to provide a soy protein product with lower levels of purity. The soy protein product is highly soluble and able to produce preferably clear protein solutions under acidic conditions.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit the oxidation of any phenolics present in the soy protein solution.

The optional concentration step and the optional diafiltration step may be effected at any convenient temperature, generally about 2° to about 65° C., preferably about 50° to about 60° C. when the procedure of U.S. patent applications Ser. Nos. 12/603,087, 12/923,897 and 12/998,422 is followed or preferably about 20° to about 35° C. when the procedure of U.S. patent applications Ser. Nos. 12/828,212, 13/067,201 and 13/378,680 is followed, and for the period of time to effect the desired degree of concentration and diafiltration. The temperature and other conditions used to some degree depend upon the membrane equipment used to effect the membrane processing, the desired protein concentration of the solution and the efficiency of the removal of contaminants to the permeate.

There are two main trypsin inhibitors in soy, namely the Kunitz inhibitor, which is a heat-labile molecule with a molecular weight of approximately 21,000 Daltons, and the Bowman-Birk inhibitor, a more heat-stable molecule with a molecular weight of about 8,000 Daltons. The level of trypsin inhibitor activity in the final soy protein product can be controlled by manipulation of various process variables.

As noted above, heat treatment of the acidified aqueous soy protein solution may be used to inactivate heat-labile trypsin inhibitors. The partially concentrated or fully concentrated acidified aqueous soy protein solution may also be heat treated to inactivate heat labile trypsin inhibitors. When the heat treatment is applied to the partially concentrated acidified aqueous soy protein solution, the resulting heat treated solution may then be additionally concentrated.

In addition, the concentration and/or diafiltration steps may be operated in a manner favorable for removal of trypsin inhibitors in the permeate along with the other contaminants. Removal of the trypsin inhibitors is promoted by using a membrane of larger pore size, such as about 30,000 to about 1,000,000 Da, operating the membrane at elevated temperatures, such as about 30° to about 65° C., preferably about 50° to about 60° C., and employing greater volumes of diafiltration medium, such as about 10 to about 40 volumes.

Acidifying and membrane processing the protein solution when the procedure of U.S. Ser. Nos. 12/603,087, 12/923,897 and 12/998,422 is carried out and extracting and/or membrane processing the protein solution when the procedure of Ser. Nos. 12/828,212, 13/067,201 and 13/378,680 is carried out at a lower pH of about 1.5 to about 3 may reduce the trypsin inhibitor activity relative to processing the solution at higher pH of about 3 to about 4.4 when the procedure of U.S. Ser. Nos. 12/603,087, 12/923,897 and 12/998,422 is carried out and about 3 to about 5 when the procedure of U.S. Ser. Nos. 12/828,212, 13/067,201 and 13/378,680 is carried out. When the protein solution is concentrated and/or diafiltered at the low end of the pH range, it may be desired to raise the pH of the protein solution prior to drying. The pH of the concentrated and/or diafiltered protein solution may be raised to the desired value, for example pH 3, by the addition of any convenient food grade alkali such as sodium hydroxide.

Further, a reduction in trypsin inhibitor activity may be achieved by exposing soy materials to reducing agents that disrupt or rearrange the disulfide bonds of the inhibitors. Suitable reducing agents include sodium sulfite, cysteine and N-acetylcysteine.

The addition of such reducing agents may be effected at various stages of the overall process. For example, the reducing agent may be added with the soy protein source material in the extraction step, may be added to the clarified aqueous soy protein solution following removal of residual soy protein source material, may be added to the concentrated protein solution before or after diafiltration or may be dry blended with the dried soy protein product. The addition of the reducing agent may be combined with a heat treatment step and the membrane processing steps, as described above.

If it is desired to retain active trypsin inhibitors in the optionally concentrated protein solution, this can be achieved by eliminating or reducing the intensity of the heat treatment step, not utilizing reducing agents, operating the concentration and/or diafiltration steps at the higher end of the pH range, such as pH 3 to about 4.4 when the procedure of U.S. Ser. Nos. 12/603,087, 12/923,897 and 12/998,422 is carried out and about 3 to about 5.0 when the procedure of U.S. Ser. Nos. 12/828,212, 13/067,201 and 13/378,680 is carried out, utilizing a concentration and/or diafiltration membrane with a smaller pore size, operating the membrane at lower temperatures and employing fewer volumes of diafiltration medium. If it is desired to lower the pH of the protein solution prior to drying, this may be done so by the addition of any convenient food grade acid such as hydrochloric acid or phosphoric acid.

The optionally concentrated and optionally diafiltered protein solution may be subject to a further defatting operation, if required, as described in U.S. Pat. Nos. 5,844,086 and 6,005,076. Alternatively, defatting of the optionally concentrated and optionally diafiltered protein solution may be achieved by any other convenient procedure.

The optionally concentrated and optionally diafiltered aqueous protein solution may be treated with an adsorbent, such as powdered activated carbon or granulated activated carbon, to remove colour and/or odour compounds. Such adsorbent treatment may be carried out under any convenient conditions, generally at the ambient temperature of the protein solution. For powdered activated carbon, an amount of about 0.025% to about 5% w/v, preferably about 0.05% to about 2% w/v, is employed. The adsorbent may be removed from the soy protein solution by any convenient means, such as by filtration.

The optionally concentrated and optionally diafiltered aqueous soy protein solution may be dried by any convenient technique, such as spray drying or freeze drying.

A pasteurization step may be effected on the soy protein solution prior to drying. Such pasteurization may be effected under any desired pasteurization conditions. Generally, the optionally concentrated and optionally diafiltered soy protein solution is heated to a temperature of about 55° to about 70° C., preferably about 60° to about 65° C., for about 30 seconds to about 60 minutes, preferably about 10 minutes to about 15 minutes. The pasteurized soy protein solution then may be cooled for drying, preferably to a temperature of about 25° to about 40° C.

The dry soy protein product has a protein content in excess of about 60 wt % (N×6.25) d.b. Preferably, the dry soy protein product is an isolate with a high protein content, in excess of about 90 wt% (N×6.25) d.b., preferably at least about 100 wt % (N×6.25) d.b.

The soy protein products, prepared by the above described procedures are suitable for use in dairy analogue or plant/dairy frozen dessert mixes used to prepare frozen dessert products, as described above.

### EXAMPLES

### Example 1

This Example illustrates the production of a soy protein isolate (S701) used in the preparation of a frozen dessert.

30 kg of defatted soy white flake was added to 300 L of 0.15M CaCl₂ solution at ambient temperature and agitated for 30 minutes to provide an aqueous protein solution. The residual soy white flake was removed and the resulting protein solution was clarified by centrifugation to provide ‘a’ L of protein solution having a protein content of ‘b’ % by weight.

‘c’ L of protein solution was then added to ‘d’ L of reverse osmosis purified water and the pH of the sample lowered to ‘e’ with a solution of HCl. The diluted and acidified solution was then heat treated at 90° C. for 30 seconds.

The heat treated acidified protein solution was reduced in volume from ‘f’ L to ‘g’ L by concentration on a polyethersulfone membrane, having a molecular weight cutoff of 100,000 Daltons, operated at a temperature of approximately ‘h’ ° C. At this point, the acidified protein solution, with a protein content of T wt %, was diafiltered with T L of reverse osmosis (RO) purified water, with the diafiltration operation conducted at approximately ‘k’ ° C. The diafiltered solution was then further concentrated to a volume of ‘1’ L and diafiltered with an additional ‘m’ L of RO water, with the diafiltration operation conducted at approximately ‘n’ ° C. After this second diafiltration, the protein solution was concentrated from a protein content of ‘o’ to a protein content of ‘p’ % by weight then diluted to a protein content of ‘q’ % by weight with water to facilitate spray drying. The protein solution before spray drying was recovered in a yield of ‘r’ wt % of the initial centrifuged protein solution. The acidified, diafiltered, concentrated and diluted protein solution was then dried to yield a product found to have a protein content of ‘s’% (N×6.25) d.b. The product was given designation ‘t’ S701H. The parameters ‘a’ to ‘t’ for five runs are set forth in the following Table 1.

TABLE 1
Parameters for the production of S701H

| | S019- | S019- | S019- | S019- | S019- |
|---|---|---|---|---|---|
| t | D15-10A | D19-10A | D20-10A | D21-10A | D26-10A |
| a | 209.3 | 233 | 228 | 221 | 240 |
| b | 2.76 | 2.83 | 2.69 | 2.79 | 2.57 |
| c | 209.3 | 233 | 228 | 221 | 240 |
| d | 220 | 245 | 249 | 239 | 260 |
| e | 3.27 | 3.14 | 3.05 | 3.29 | 3.00 |
| f | 408 | 485 | 500 | 480 | 505 |
| g | 89 | 96 | 108 | 107 | 112 |
| h | 30 | 50 | 29 | 50 | 30 |
| i | 4.99 | 5.81 | 4.77 | 4.73 | 4.65 |
| j | 134 | 144 | 162 | 160 | 168 |
| k | 30 | 51 | 29 | 50 | 29 |
| l | 41 | 48 | 47 | 48 | 48 |
| m | 308 | 360 | 353 | 360 | 360 |
| n | 30 | 49 | 30 | 51 | 30 |
| o | 9.66 | 10.85 | 9.89 | 9.34 | 9.80 |
| p | 11.78 | 13.49 | 11.78 | 11.86 | 12.11 |
| q | 5.94 | 6.22 | 5.02 | 5.55 | 6.00 |
| r | 74.0 | 79.2 | 66.4 | 77.3 | 78.3 |
| s | 100.53 | 102.43 | 102.10 | 102.45 | 102.22 |

Batches of S701H were dry blended in the proportions shown below to provide a composite product called Clarisoy XIII S701H (Table 2).

TABLE 2
Proportion of products in Clarisoy XIII S701H

| | Proportion of total product |
|---|---|
| Batch | weight (%) |
| S019-D15-10A | 16.9 |
| S019-D19-10A | 21.7 |
| S019-D20-10A | 21.2 |
| S019-D21-10A | 20.7 |
| S019-D26-10A | 19.5 |

### Example 2

This Example illustrates the production of frozen desserts used for the sensory evaluation. Frozen desserts were prepared using either the Clarisoy XIII S701H, prepared as described in Example 1, or Ardex F dispersible (ADM, Decatur, Ill.), a commercial soy protein isolate recommended for use in applications including imitation dairy-type products.

Sufficient protein powder to supply 14.4 g of protein was weighed out and approximately 550 ml of purified drinking water was added. The sample was stirred until the protein was well dispersed (Ardex F) or completely solubilized (Clarisoy XIII S701H). The pH of the Ardex F solution was 6.90. The pH of the Clarisoy XIII S701H solution was adjusted from 3.46 to 6.91 using food grade NaOH. To the pH adjusted solutions was added 7.2 g of soybean oil (Crisco Vegetable Oil, Smucker Foods of Canada Co., Markham, ON) and the volumes of the samples brought up to 600 ml with additional water. The samples were then processed at 5,000 rpm for 3 minutes on a Silverson L4RT mixer equipped with a fine emulsor screen.

Samples of each soy protein solution (507.16 g) were weighed out and then pure vanilla extract (1.99 g) (Club House, McCormick Canada, London, ON) and granulated sugar (89.85 g) (Rogers, Lantic Inc., Montreal, QC) added and the mixture stirred until the sugar completely dissolved. The pH of the mixes was determined. The mix prepared with Ardex F had a pH of 6.98. The pH of the mix prepared with Clarisoy was raised from 6.76 to 6.98 using food grade NaOH. The mixes were then chilled to a temperature of 9° C. Each chilled mix was transferred to the bowl of a Cuisinart ICE-50BCC ice cream maker. The ice cream maker was run for 45 minutes yielding a semisolid frozen dessert. The temperature of the freshly prepared Ardex F frozen dessert was −3° C. The temperature of the freshly prepared Clarisoy frozen dessert was −4° C. The products were transferred to plastic tubs and stored overnight in a freezer at about −8° C. The next day the samples, having a temperature of −5° C., were presented to the sensory panel.

### Example 3

This Example illustrates the sensory evaluation of the frozen desserts prepared as described in Example 2.

Samples of the frozen desserts were transferred to small cups then presented blindly to an informal panel with 9 panelists. The panel was asked to identify which sample had more beany flavour and which sample they preferred the flavour of Six out of nine panelists found the frozen dessert prepared with Ardex F to have more beany flavour than the dessert prepared with Clarisoy XIII S701H. Seven out of nine panelists preferred the flavour of the dessert prepared with Clarisoy XIII S701H.

### Example 4

This Example illustrates the production of a soy protein isolate (S703) used in the preparation of the frozen dessert.

20 kg of defatted, minimally heat treated soy flour was added to 200 L of 0.15 M calcium chloride solution at ambient temperature and agitated for 30 minutes to provide an aqueous protein solution. Immediately after the flour was dispersed in the calcium chloride solution, the pH of the system was adjusted to 3 by the addition of diluted HCl. The pH was monitored and corrected to 3 periodically over the course of the 30 minute extraction. The residual soy flour was removed by centrifugation to yield 174 L of protein solution having a protein content of 3.37% by weight. The protein solution was then combined with 174 L of reverse osmosis purified water and the pH corrected to 3. This solution was then polished by filtration to yield 385 L of filtered protein solution having a protein content of 1.21% by weight.

The filtered protein solution was reduced in volume to 25 L by concentration on a PVDF membrane having a molecular weight cutoff of 5,000 Daltons, operated at a temperature of about 29° C. The concentrated protein solution was then diafiltered with 125 L of reverse osmosis purified water, with the diafiltration operation conducted at a temperature of about 29° C. The resulting diafiltered, concentrated protein solution had a protein content of 14.51% by weight and represented a yield of 81.3 wt % of the filtered protein solution. The diafiltered, concentrated protein solution was then dried to yield a product found to have a protein content of 99.18% (N×6.25) d.b. The product was termed S005-A13-09A 5703

### Example 5

This Example illustrates the production of frozen desserts used for the sensory evaluation. Frozen desserts were prepared using either the S005-A13-09A 5703, prepared as described in Example 4, or Ardex F dispersible (ADM, Decatur, Ill.), a commercial soy protein isolate recommended for use in applications including imitation dairy-type products.

Sufficient protein powder to supply 14.4 g of protein was weighed out and approximately 550 ml of purified drinking water was added. The sample was stirred until the protein was well dispersed (Ardex F) or completely solubilized (5005-A13-09A S703). The pH of the Ardex F solution was 6.96. The pH of the 5005-A13-09A 5703 solution was adjusted from 3.11 to 6.98 using food grade NaOH. To the pH adjusted solutions was added 7.2 g of soybean oil (Crisco Vegetable Oil, Smucker Foods of Canada Co., Markham, ON) and the volumes of the samples brought up to 600 ml with additional water. The samples were then processed at 5,000 rpm for 3 minutes on a Silverson L4RT mixer equipped with a fine emulsor screen.

Samples of each soy protein solution (507.16 g) were weighed out and then pure vanilla extract (1.99 g) (Club House, McCormick Canada, London, ON) and granulated sugar (89.85 g) (Rogers, Lantic Inc., Montreal, QC) added and the mixture stirred until the sugar completely dissolved. The pH of the mixes was determined. The mix prepared with Ardex F had a pH of 6.98. The pH of the mix prepared with S005-A13-09A S703 was 6.97. The mixes were then chilled to a temperature of 9° C. Each chilled mix was transferred to the bowl of a Cuisinart ICE-50BCC ice cream maker. The ice cream maker was run for 45 minutes yielding a semisolid frozen dessert. The freshly prepared Ardex F and S005-A13-09A 5703 frozen desserts both had a temperature of −3° C. The products were transferred to plastic tubs and stored overnight in a freezer at between about −8° C. and −10° C. The next day the samples, having a temperature of −6° C., were presented to the sensory panel.

### Example 6

This Example illustrates the sensory evaluation of the frozen desserts prepared as described in Example 5.

Samples of the frozen desserts were transferred to small cups then presented blindly to an informal panel with 9 panelists. The panel was asked to identify which sample had more beany flavour and which sample they preferred the flavour of Eight out of nine panelists found the frozen dessert prepared with Ardex F to have more beany flavour than the dessert prepared with S005-A13-09A S703. Seven out of nine panelists preferred the flavour of the dessert prepared with 5005-A13-09A S703.

### SUMMARY OF THE DISCLOSURE

In summary of this disclosure, dairy analogue or plant/dairy blend, frozen dessert mixes used in the production of frozen dessert products having favourable flavour properties are provided using soy protein products. Modifications are possible within the scope of this invention.

What we claim is:

1. A frozen dessert mix having a composition that includes protein, fat, flavourings, sweetener, stabilizers and emulsifiers in sufficient proportions to provide a desired composition of frozen dessert product, wherein the protein component is provided at least in part by a soy protein product having a protein content of at least about 60 wt % (N×6.25) d.b. and being completely soluble at said pH values of less than 4.4 and heat stable at such pH values.

2. The mix of claim 1 wherein said mix has a composition that includes:
0 to about 30 wt % fat
0.1 to about 18 wt % protein
0 to about 45 wt % sweetener
0 to about 3 wt % stabilizer
0 to about 4 wt % emulsifier

3. The mix of claim 1 wherein said mix has a composition that includes:
0 to about 18 wt % fat
0.1 to about 6 wt % protein
0 to about 35 wt % sweetener
0 to about 1 wt % stabilizer
0 to about 2 wt % emulsifier

4. The mix of claim 1 which contains no dairy ingredients and can be classified as a dairy analogue frozen dessert mix.

5. The mix of claim 1 which contains a blend of plant and dairy ingredients.
